(19) United States
(12) Patent Application Publication
(10) Pub. No.: US 2009/0150671 A1
(43) Pub. Date: Jun. 11, 2009

(54) COMMUNICATION SYSTEM AND COMMUNICATION TERMINAL DEVICE

(76) Inventor: Hiroshi ABE, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/327,708

(22) Filed: Dec. 3, 2008

(30) Foreign Application Priority Data
Dec. 6, 2007 (JP) 2007-315937

(51) Int. Cl. H04L 9/00

(52) U.S. Cl. 713/169

(57) ABSTRACT

There is provided a communication terminal device configured to include: a mutual authentication unit that performs mutual authentication with a service providing server; an obtaining unit that obtains biometric information of an authentication target associated with an encryption key common to the service providing server, which is obtained as a successful result of the mutual authentication performed by the mutual authentication unit; a biometric authentication unit that performs biometric authentication by using the biometric information of the authentication target, which has been obtained by the obtaining unit, and biometric information of a registration target; and a notification unit that encrypts a message indicating that the biometric authentication has succeeded, by using the encryption key and notifies the service providing server of the message, if the biometric authentication of the biometric authentication unit succeeds.

### CROSS REFERENCES TO RELATED APPLICATIONS

The present invention contains subject matter related to Japanese Patent Application JP 2007-315937 filed in the Japanese Patent Office on Dec. 6, 2007, the entire contents of which being incorporated herein by reference.

### BACKGROUND OF THE INVENTION

1. Field of the Invention

The present invention relates to a communication system and a communication terminal device which are suitably used for, for example, providing services via the Internet.

2. Description of the Related Art

There has been proposed a communication system in which mutual authentication is performed between communication terminals by employing an open key encryption method and information concerning a predetermined service is communicated if the mutually authentication is successful (refer to, e.g., Jpn. Pat. Appln. Laid-open Publication No. 2004-110433).

In this communication system, each communication terminal can confirm that another communication terminal as a communication partner is an authorized communication terminal. However, even if a user of the communication terminal as a communication partner is not an authorized user, communication is allowed insofar as mutually authentication is successful.

Consequently, there is a problem that a third party can masquerade as an authorized user and receive services by using a communication terminal which plural persons can use, such as a personal computer owned by a company, or by using a stolen personal communication terminal.

In this respect, in the communication system according to the aforementioned publication, a communication terminal as a service receiver performs biometric authentication by using biometric information. If the biometric authentication is successful, mutual authentication is performed between the communication terminal as a service receiver and a communication terminal as a service provider.

### SUMMARY OF THE INVENTION

However, the communication terminal as a service provider does not know whether the communication terminal as a service receiver has a biometric authentication function or not. Therefore, if a third party accesses the communication terminal as a service provider by using a communication terminal equipped with no biometric authentication function, the third party can disguise itself as an authorized user and receive services.

The present invention has been made in view of the problems as described above and proposes a communication system and a communication terminal device which are capable of strengthening spoofing prevention.

According to an aspect of the present invention to solve problems as described above, a communication system is configured to include a service providing server capable of making communications through a predetermined network, and a communication terminal device, wherein the service providing server includes: a mutual authentication unit that performs mutual authentication with the communication terminal device; and a service providing unit that performs a service providing processing if a message indicating that the mutual authentication has succeeded is notified of from the communication terminal device, and the communication terminal device includes: a mutual authentication unit that performs mutual authentication with the communication terminal device; and an obtaining unit that obtains biometric information of an authentication target associated with an encryption key common to the service providing server, which is obtained as a successful result of the mutual authentication performed by the mutual authentication unit; a biometric authentication unit that performs biometric authentication by using the biometric information of the authentication target which has been obtained by the obtaining unit, and biometric information of a registration target; and a notification unit that encrypts the message by using the encryption key and notifies the service providing server of the message, if the biometric authentication of the biometric authentication unit succeeds.

According to another aspect of the present invention, a communication terminal device is configured to include: a mutual authentication unit that performs mutual authentication with a service providing server; an obtaining unit that obtains biometric information of an authentication target associated with an encryption key common to the service providing server, which is obtained as a successful result of the mutual authentication performed by the mutual authentication unit; a biometric authentication unit that performs biometric authentication by using the biometric information of the authentication target, which has been obtained by the obtaining unit, and biometric information of a registration target; and a notification unit that encrypts a message indicating that the biometric authentication has succeeded, by using the encryption key and notifies the service providing server of the message, if the biometric authentication of the biometric authentication unit succeeds.

In the present invention configured as described above, a mutual authentication result (encryption key) is associated with biometric information which have been input a user who carried out mutual authentication by use of a communication terminal device. Therefore, if a service providing server which has received a message indicating successful biometric authentication encrypted by use of the encryption key can decrypt the encrypted message by using an encryption key common to the communication terminal device, the service providing server recognizes that not only the communication terminal device is authorized but also the user using the communication terminal device is also authorized. As a result, a communication system and a communication terminal device which can strengthen spoofing prevention are achieved.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic diagram showing a structure of a service providing system according to an embodiment;

FIG. 2 is a block diagram showing a structure of a mobile phone;

FIG. 3 is a block diagram showing a functional structure of a certificate obtaining mode for a security chip;

FIG. 4 is a schematic diagram showing a profile of a qualified certificate;

FIG. 5 is a block diagram showing a functional structure of a service receiving mode for the security chip; and

FIG. 6 is a sequence chart showing a mutual authentication procedure based on a public key certificate.

### DETAILED DESCRIPTION OF THE PREFERRED EMBODIMENTS

An embodiment of the present invention will now be described with reference to the drawings.

### (1) Structure of Service Providing System

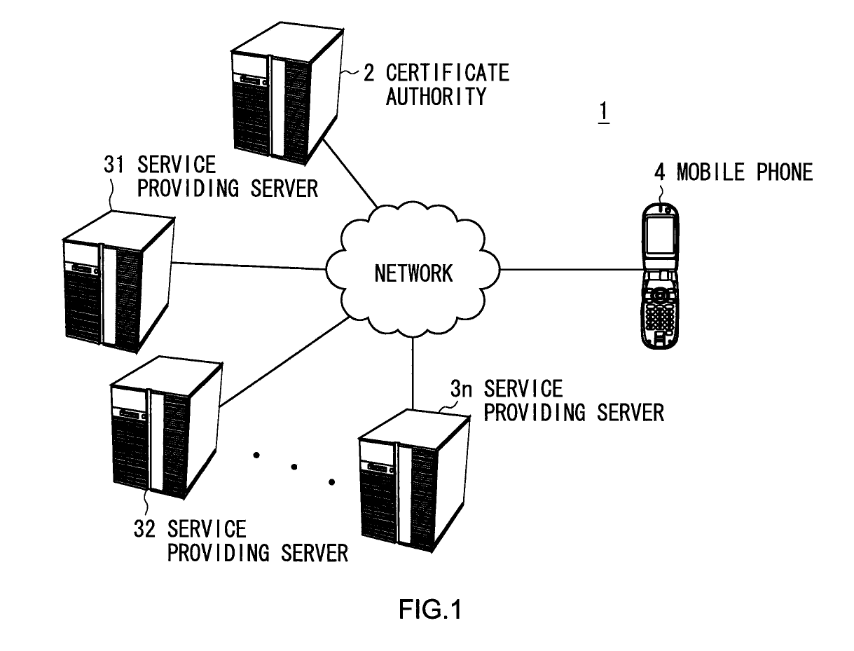

FIG. 1 shows an overall structure of a service providing system 1 according to an embodiment. In the service providing system 1, a public key certificate authority (certificate authority: CA) 2, plural service providing servers 3₁, 3₂, . . . , 3ₙ, and a mobile phone 4 are mutually connected via a network 5 such as the Internet or a next generation network (NGN).

The certificate authority 2 is a server that certifies identities of users and is configured so as to issue public key certificates (PKC) to requestors who request certification via the network 5.

Each of the public key certificates is created by using a public key infrastructure (PKI) and includes a user identification (ID), such as a user name, MAC address, or mail address, and a public key associated with the user ID, which are added with a digital signature. The digital signature is generated by encrypting, with use of a secret key for signature, fixed-length data such as a hash value which is derived from a user ID and a public key by use of a one-way function.

Meanwhile, the service providing servers 3₁, 3₂, . . . , 3ₙ provide predetermined services via the network 5. The service providing servers 3₁, 3₂, . . . , 3ₙ each are configured so as to provide their own services for service receivers by using user attribute information such as users' access rights for services.

The mobile phone 4 is a terminal device which can communicate with a service providing server 3ₓ (3₁, 3₂, . . . , or 3ₙ) via a network.

When the mobile phone 4 receives a service via a network, the mobile phone 4 obtains a public key certificate which certifies an identify of a user from the certificate authority 2, and also obtains vein information of the user.

When the mobile phone 4 receives a service from the service providing server 3ₓ, the mobile phone 4 performs a mutual authentication with the service providing server 3ₓ by using the public key certificate, and also performs a biometric authentication with use of the vein information. If both authentications are successful, the mobile phone 4 can receive a service form the service providing server 3ₓ.

### (2) Structure of Mobile Phone

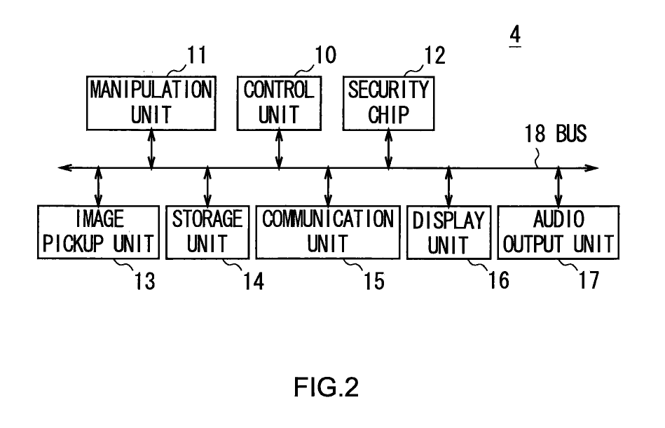

Next, a structure of the mobile phone 4 will be described with reference to FIG. 2. The mobile phone 4 is constituted by connecting a manipulation unit 11, a security chip 12, an image pickup unit 13, a storage unit 14, a communication unit 15, a display unit 16, and an audio output unit 17 each to a control unit 10 through a bus 18.

The control unit 10 is constituted as a computer including a main central processing unit (CPU), which controls the whole mobile phone 4, a read only memory (ROM) and a random access memory (RAM) as a work memory of the main CPU.

The control unit 10 appropriately controls the image pickup unit 13, storage unit 14, communication unit 15, display unit 16, and audio output unit 17, based on programs corresponding to commands given from the manipulation unit 11. As processings corresponding to the commands, the control unit 10 performs various processings such as a download processing, a server access processing, a call processing, a communication processing, a mail creation processing, and a mail transfer processing, etc.

The security chip 12 is packaged into a structure including a sub CPU which controls the security chip 12, a ROM, a RAM as a work memory for the sub CPU, and a storage unit (which will be hereinafter called a security storage unit.)

The ROM contains a tamper proof program such as a program which protects the security storage unit from unauthorized access or a program which erases data in the security storage unit in accordance with unauthorized access. The security chip 12 is configured so as to manage the security storage unit to be maintained at a higher security level than the storage unit 14.

This ROM also contains programs which respectively support a mode for obtaining a public key certificate (hereinafter, called a certificate obtaining mode) and a mode for receiving services (hereinafter, called a service receiving mode). Upon receiving an execution command for the certificate obtaining mode or service receiving mode, based on the program corresponding to the execution command, the security chip 12 appropriately controls the image pickup unit 13, storage unit 14, communication unit 15, display unit 16, and audio output unit 17, to execute the certificate obtaining mode or the service receiving mode.

The image pickup unit 13 generates and obtains, as image data, an image of an object to be imaged within an image pickup range, and sends the obtained image data to the control unit 10.

In case of a vein registration mode or an authentication mode, the image pickup unit 13 illuminates a light incidence surface with light having a wavelength within a wavelength range (700 nm to 900 nm: light in this range is called near infrared light) which has characteristic of being absorbable uniquely in both of deoxidized hemoglobin and oxidized hemoglobin. The image pickup unit 13 is configured so as to further generate, as data (hereinafter, called vein image data, an image of veins (hereinafter, called a vein image) in an organic portion positioned at the light incidence surface, and send the data to the control unit 10.

The storage unit 14 is to store other various information than vein information which is extracted from vein image data. The storage unit 14 stores/reads such various information into/from a predetermined area specified by the control unit 10.

The communication unit 15 is configured so as to transmit/receive signals to a network 4 (FIG. 1). Specifically, the communication unit 15 modulates input data to be communicated, by a predetermined modulation method such as an orthogonal frequency division multiplex (OFDM), and transmits a signal obtained as a modulation result to a base station through an antenna (not shown). Meanwhile, the communication unit 15 demodulates a signal received through the antenna, by a predetermined demodulation method, and outputs data obtained as a demodulation result.

The display unit 16 displays letters and figures on a display screen, based on display data supplied from the control unit 10. The audio output unit 17 is configured so as to output audio through a loudspeaker, based on audio data supplied from the control unit 10.

### (3) Certificate Obtaining Mode

Described next will be the certificate obtaining mode of the security chip 12. When the control unit 10 (FIG. 2) receives an execution command for the certificate obtaining mode, the security chip 12 functions as an image pickup condition setup unit 31, a vein information extraction unit 32, a public key pair generation unit 33, a registration unit 34, and a certificate obtaining unit 35, based on a program for the certificate obtaining mode.

Through at least one of the display unit 16 (FIG. 2) and the audio output unit 17 (FIG. 2), the image pickup condition setup unit 31 informs a user that a finger should be put on a light incidence surface. Thereafter, the image pickup condition setup unit 31 sets as an optimal image pickup condition for veins, for example, a light amount or an exposure value (EV) stored in the security storage unit to the image pickup unit 13.

The image pickup unit 13 emits near infrared light of a light amount which is set by the image pickup condition setup unit 31, and adjusts a diaphragm value for a diaphragm and a shutter speed (exposure time) for an image pickup element, with reference to the exposure value which is also set by the image pickup condition setup unit 31.

The image pickup unit 13 emits near infrared light to be irradiated to an area behind a vein layer inside a finger put on the light incidence surface. When a finger is put on the light incidence surface, the near infrared light travels through the vein layer and a skin layer, reflected and diffused inside the finger. Therefore, the incidence light is maintained bright in portions not including veins as well as dark in portions including veins due to light absorbent characteristic of hemoglobin. Accordingly, sharp contrast appears between portions not including veins and portions including veins (the light projects veins as an image).

The vein information extraction unit 32 extracts vein information indicating a pattern of veins projected as a vein image, based on vein image data which is output from the image pickup unit 13.

The vein information may be of various types, such as a vein image in which centers in width of veins or peaks in brightness are extracted, an image obtained by subjecting the vein image to Hough transform, dots forming veins included in the vein image, or parameters of curves approximated to veins included in the vein image, or a combination thereof.

The public key pair generation unit 33 generates a public key and a secret key which are compatible with the public key infrastructure (PKI).

The registration unit 34 registers the secret key generated by the public key pair generation unit 33 and the vein information extracted by the vein information extraction unit 32, by storing the secret key and the vein information associated with each other. When registering vein information, the registration unit 34 generates information indicating a registration location of the vein information (which will be hereinafter referred to as registration address information).

The certificate obtaining unit 35 encrypts the registration address information generated by the registration unit 34, using the public key generated by the public key generation unit 33. The certificate obtaining mode 35 accesses the certificate authority 2 through the communication unit, and requests issuance of a qualified certificate from the certificate authority 2.

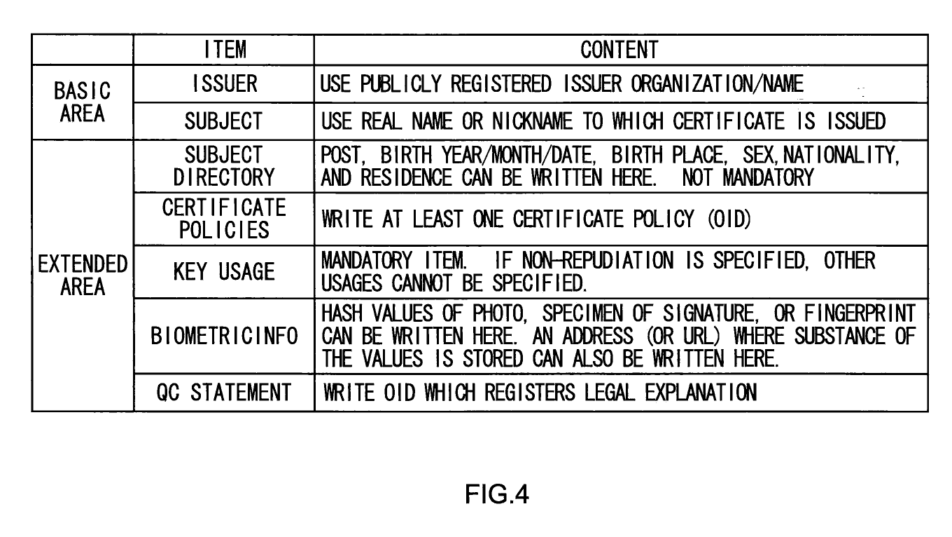

The qualified certificate is a public key certificate which is defined under RFC 3739 according to Internet Engineering Task Force (IFTD), and has a profile as shown in FIG. 4.

In case of this embodiment, the certificate obtaining unit 35 is configured so as to transmit an identification (ID) of the mobile phone 4, as a subject name, to the public key certificate authority 2, and to transmit encrypted registration address information (hereinafter, called encrypted registration address information) as biometric information in the qualified certificate also to the certificate authority 2.

The encrypted registration address information has been encrypted by a public key which can be decoded only with a secret key. Therefore, even if a third party obtains the encrypted registration address information by hacking or so, the third party cannot read content of the encrypted registration address information. Thus, the public key certificate authority 2 is configured so as to allow a partner as a transmission destination to safely obtain information (e.g., an address) appended to vein information which cannot be appropriately changed like a secret code number.

The certificate authority 2 generates and issues a qualified certificate to the mobile phone 4 as a requester. In the qualified certificate, information which includes the ID of the mobile phone 4 and the encrypted registration address information is digitally signed. Therefore, this qualified certificate does not certify identity, regarding the ID as a user itself, but does certify identities of both the device given the ID and a user using the device.

When the certificate obtaining unit 35 obtains a qualified certificate issued in response to a request for issuance of a qualified certificate, the certificate obtaining unit 35 then stores the qualified certificate into the storage unit 14 outside the security chip 12. The certificate obtaining unit 35 can therefore reduce a storage capacity of the security storage unit by a volume which is saved as the certificate obtaining unit 35 does not store the qualified certificate into the security storage unit in the security chip 12.

Thus, with respect to vein information having a vein pattern which cannot appropriately be changed like a secret code number, the security chip 12 does not send out the vein information to outside of the security chip 12 but maintains the vein information in inside of the security chip 12 where the security level is higher than in the storage unit 14 of the security chip 12. With respect to information (address) appended to the vein information, the security chip 12 sends out the information kept in a state in which, even if somebody obtains the information, the information cannot be decrypted owing to a public key which is decodable only with use of a secret key. Accordingly, vein patterns can be managed in a highly secured state.

### (4) Service Receiving Mode

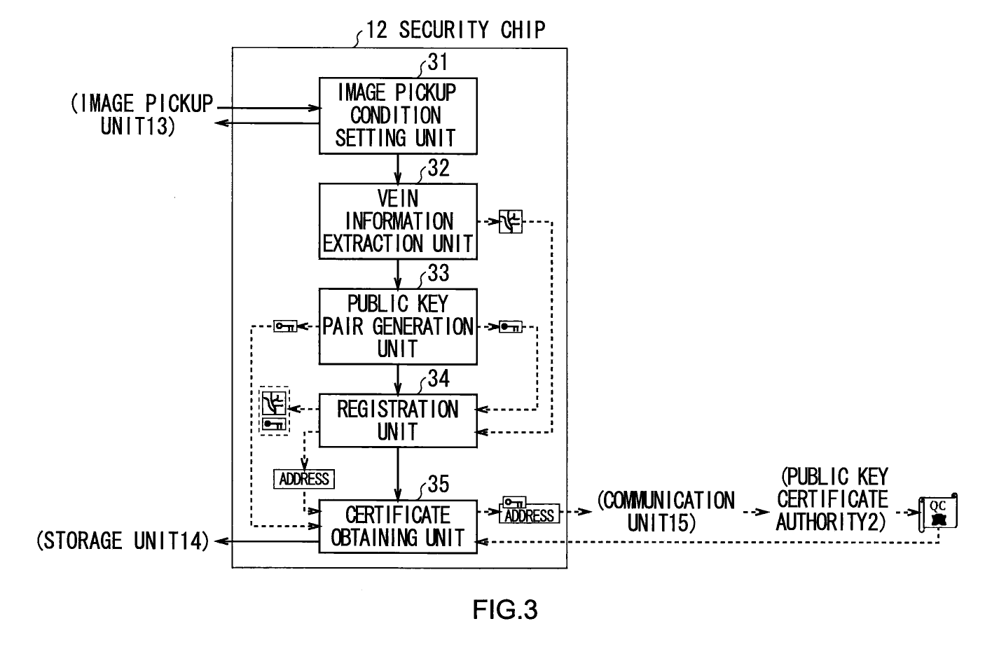

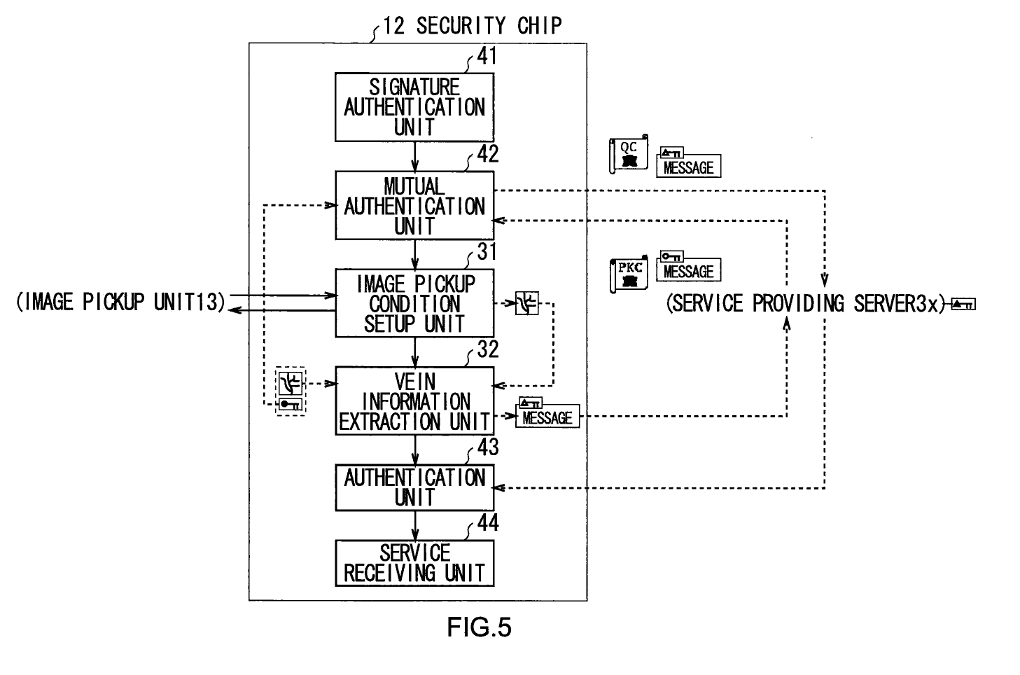

Next, the service receiving mode of the security chip 12 will be described. When the security chip 12 receives an execution command for setting the service providing server 3x in the service receiving mode from the control unit 10 (FIG. 2), the security chip 12 then functions as a signature authentication unit 41, a mutual authentication unit 42, an image pickup unit condition setup unit 31, a vein information extraction unit 32, a biometric authentication unit 43, and a service receiving unit 44, based on the program for the service receiving mode, as shown in FIG. 5 in which units common to FIG. 3 are denoted at common reference symbols.

The signature authentication unit 41 obtains a public key certificate which is issued to the service providing server 3ₓ. At this time, the public key certificate is obtained from the service providing server 3ₓ or any other repository than the service providing server 3ₓ.

The signature authentication unit 41 further performs signature authentication by using a digital signature in the public key certificate of the service providing server 3ₓ. Specifically, the signature authentication unit 41 decodes the digital signature in the public key certificate of the service providing server 3ₓ by using a public key corresponding to the public key certificate, and compares a decoding result thereof with fixed-length data derived from a body of the public key certificate (such as the ID of the service providing server 3ₓ).

If the body of the public key certificate disagrees with the fixed-length data, the disagreement implies that the body of the public key certificate has been altered and content of the body has been changed. In this case, the signature authentication unit 41 determines that the signature authentication has failed.

Otherwise, if the body of the public key certificate agrees with the fixed-length data, this agreement proves that content of the body of the public key certificate is true. In this case, the signature authentication unit 41 determines that signature authentication is successful.

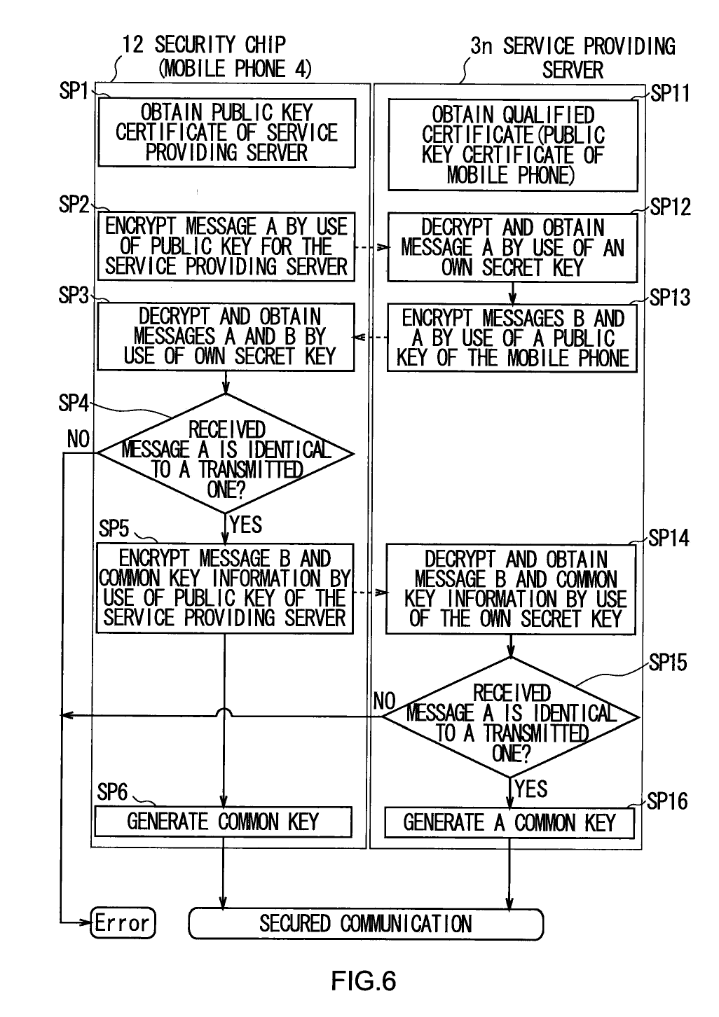

If the signature authentication unit 41 determines the signature authentication to be successful, the mutual authentication unit 42 accesses the service providing server 3ₓ through the communication unit 15 and carries out mutual authentication with the service providing server 3ₓ. That is, the authentication unit 42 obtains a public key certificate of the service providing server 3ₓ from the signature authentication unit 41, as shown in FIG. 6 (step SP1), and encrypts a message (hereinafter, called an A message) generated based on predetermined data or a random number, by using a public key corresponding to the public key certificate (step SP2). The authentication unit 42 transmits the encrypted message to the service providing server 3ₓ.

On the other side, if the service providing server 3x is accessed form the mobile phone 4, the service providing server 3x obtains a qualified certificate (public key certificate) issued to the mobile phone 4 (step SP11). The qualified certificate is obtained from the mobile phone 4 or any other repository than the mobile phone 4.

The service providing server 3ₓ then verifies the digital signature in the qualified certificate of the mobile phone 4, as in case of the mobile phone 4. The service providing server 3ₓ waits for data transmitted from the mobile phone 4 if content of the body (e.g., the ID of the mobile phone and the encrypted registration address information) of the qualified certificate is proved to be true. Upon receiving the encrypted message transmitted from the mobile phone 4, the service providing server 3ₓ decodes the encrypted message by using an own secret key, and thereby obtains a plain text (hereinafter, called a message A) (step SP12).

Further, the service providing server 3ₓ encrypts the message A and a message generated by predetermined data or a random number (hereinafter, called a message B) by using a public key corresponding to the qualified certificate of the mobile phone 4 (step SP13). The encrypted messages are sent back to the mobile phone 4.

Upon receiving the encrypted messages from the service providing server 3ₓ, the mutual authentication unit 42 decrypts the encrypted messages by using an own secret key, and thereby obtains a plain text (messages A and B) (step SP3). The mutual authentication unit 42 checks whether or not the plain text includes the same text as the message A generated by the mutual authentication unit 42 (step SP4).

If the same text as the message A generated by the mutual authentication unit 42 is not included (step SP4: NO), no inclusion of the same text implies that a transmission destination of the message A disguises itself as the service providing server 3ₓ or there is some party who interferes with communication with the service providing server 3ₓ. In this case, the mutual authentication unit 42 determines that mutual authentication has failed.

Otherwise, if the same text as the message A generated by the mutual authentication unit 42 is included (step SP4: YES), the mutual authentication unit 42 determines that the communication partner is an authorized communication partner, and generates information concerning a common key to be used later for the communication (which will be hereinafter called common key information). The mutual authentication unit 42 encrypts the common key information and the message B by using a public key corresponding to the public key certificate of the service providing server 3ₓ (step SP5). The mutual authentication unit 42 sends back the encrypted message to the service providing server 3ₓ, and thereafter generates a common key from common key information (step SP6).

On the other side, when the service providing server 3ₓ receives the encrypted messages sent back from the mobile phone 4, the service providing server 3ₓ then decrypts the encrypted message by using an own secret key, and thereby obtains a plain text (the common key information and the message B) (step SP14). The service providing server 3ₓ checks whether or not the same text as the message B generated by the service providing server 3ₓ is included in the plain text (step SP15).

If the B message generated by the service providing server 3ₓ is not included (step SP15: NO), the service providing server 3ₓ determines that mutual authentication has failed, and shut off the communication route to the mobile phone 4. Otherwise, if the same text as the message A generated by the service providing server 3ₓ is included (step SP15: YES), the service providing server 3ₓ determines the communication partner to be an authorized communication partner, and generates a common key from the common key information obtained from the mobile phone (step SP16). Further, the service providing server 3ₓ encrypts a message indicating successful authentication by using the common key, and transmits the encrypted message to the mobile phone 4.

When the mutual authentication unit 42 receives the encrypted message, the mutual authentication unit 42 then tries to decrypt the encrypted message by using a common key. If the encrypted message can be decrypted by the common key, mutual authentication is determined to be successful. Otherwise, if the encrypted message cannot be decrypted by the common key or if the communication route to the service providing server 3ₓ is shut off, mutual authentication is determined to be successful.

In this manner, the mutual authentication unit 42 is configured so as to perform mutual authentication with the service providing server 3ₓ, and to share information concerning the common key with the service providing server 3ₓ in process of the mutual authentication.

If mutual authentication is determined to be successful as a determination result made by the mutual authentication unit 42, the image pickup condition setup unit 31 (FIG. 5) sets up an optimal image pickup condition for veins in the image pickup unit 13. The vein information extraction unit 32 extracts vein information of an authentication target, based on vein information data output from the image pickup unit 13.

The biometric authentication unit 43 (FIG. 5) compares vein information of a registration target, which has been stored in the security storage unit in the security chip 12, with vein information of an authentication target which has been extracted by the vein information extraction unit 32. The biometric authentication unit 43 thereby detects similarity between the former vein information and the latter vein information.

For example, if vein information is a vein image in which centers in width of veins or peaks in brightness are extracted or an image obtained by subjecting the vein image to Hough transform, the similarity is detected by a cross-correlation function, a phase correlation function, or a sum of absolute difference (SAD). Otherwise, if vein information is expressed as dots expressing veins included in a vein image or vein information indicates parameters of curves approximated to veins included in the vein image, the vein image is recovered based on the vein information, and thereafter, the similarity is detected by a cross-correlation function or the like.

If the similarity concerning the vein information is not smaller than a predetermined threshold, the biometric authentication unit 43 determines biometric authentication to be successful. Otherwise, if the similarity concerning the vein information is smaller than the threshold, biometric authentication is determined to have failed.

If authentication is determined to have failed as a result of determination made by the mutual authentication unit 42 or the biometric authentication unit 43, the service receiving unit 43 informs a user that the user cannot receive services from the service providing server 3x, through at least one of the display unit 16 (FIG. 2) and the audio output unit 17 (FIG. 2).

Otherwise, if authentication is determined to be successful as a determination result in the biometric authentication unit 43, signature authentication by the signature authentication unit 41 and mutual authentication by the mutual authentication unit 42 have already been determined to be successful. In this case, the service receiving unit 43 generates a message indicating that biometric authentication is successful, and encrypts the message by using the common key (FIG. 6: step SP6) generated through the mutual authentication process by the mutual authentication unit 42. The service receiving unit 43 further transmits the encrypted message to the service providing server 3ₓ through the communication route to communication unit 15.

The service providing server 3ₓ receives the encrypted message and then decrypts the message. If a plain text of the decrypted message is a message indicating successful biometric authentication, the service providing server 3ₓ starts providing a service.

If the service is provided for the first time, the service providing server 3ₓ encrypts information for setting up user attribute information by using the common key generated in mutual authentication process for mutual authentication with the mobile phone 4 (FIG. 6: step SP16), and transmits the encrypted information to the mobile phone 4.

In this case, the service receiving unit 43 decrypts the encrypted information by using the common key, and shows a setup screen as a graphical user interface (GUI) for setting up user attribute information on the display unit 16, based on the information obtained as a result of decryption.

For example, if the service providing server 3ₓ is a server which provides a bank transaction such as browsing of a back account or an exchange transaction, a setup screen is displayed as a GUI, including items for inputting a name, a residential address, year and date of birth, and sex, and an item for selecting a desired service from an account balance inquiry, an account activity inquiry, a bank transfer, an account transfer, a financial product (a term deposit, a foreign exchange deposit, or an investment trust), purchase of a lottery ticket, or PayPal.

For example, if the service providing server 3ₓ is a server which provides contents such as audio, videos, or game software, a setup screen is displayed as a GUI, including items for inputting a name, a residential address, year and date of birth, and sex, items for selecting various contents such as game contents, video contents, music contents, and still image contents, which are provided by a content providing server, and an item for selecting a use style such as an expiry date or a usage count.

Upon completion of setting up on the setup screen, the service receiving unit 43 encrypts the user attribute information set up through the setup screen by using the common key, and transmits the encrypted information to the service providing server 3ₓ.

The service providing server 3ₓ receives the encrypted information, and then decrypts the encrypted information. In accordance with the user attribute information obtained as a result of decryption, the service providing server 3ₓ executes a service providing processing, and manages the user attribute information on a database.

Otherwise, if a service is provided for the second time or later, the service providing server 3ₓ searches the database for the user attribute information of the mobile phone 4, and executes a service providing processing in accordance with the user attribute information searched for.

### (5) Operation and Effect

In the structure as described above, the mobile phone 4 performs mutual authentication with the service providing server 3ₓ, and thereafter obtains a common key which is shared with the service providing server 3ₓ, for common use in later communications (FIG. 6).

Further, if the mutual authentication is successful, the mobile phone 4 obtains vein information of an authentication target to be authenticated by the common key, through the image pickup condition setup unit 31 (FIG. 5) and the vein information extraction unit 32 (FIG. 5). By the mobile phone 4, biometric information which must have been input by a user who tried mutual authentication when the mutual authentication succeeded is therefore associated with the common key which is regarded as a proof of the successful mutual authentication (device authentication).

In this state, the mobile phone 4, the mobile phone 4 performs biometric authentication by using vein information of the authentication target and vein information of a registration target. If the biometric authentication is successful, the mobile phone 4 encrypts a message indicating the successful biometric authentication by the common key, and notifies the service providing server 3ₓ of the message.

Accordingly, if the service providing server 3ₓ can decrypt the encrypted message by using the common key, the service providing server 3ₓ recognizes that not only the communication terminal device is authorized but also the user using the communication terminal device is also authorized.

As a result, for example, the service providing server 3ₓ can detect spoofing even when a third party disguises itself as an authorized user by using a communication terminal which can be shared for common use by plural users, such as a personal computer owned by a company, a stolen personal communication terminal, or a communication terminal equipped with no biometric authentication function.

Further, when registering vein information of a registration target, the public key certificate authority 2 issues information (registration address information) indicating a storage location of the vein information of the registration target of the mobile phone 4 in this embodiment, identification information (ID of the mobile phone 4) indicating an own communication terminal, and a qualified certificate (FIG. 4) including a signature for verifying both of the foregoing information.

Therefore, the mobile phone 4 does not only obtain vein information of a registration target which is used for biometric authentication, from the registration target, but also register the vein information as information for which a relationship with the user using the mobile phone 4 has been proved by a third-party organization other than the mobile phone 4 and the service providing server 3ₓ. Therefore, the relationship between a device and a living body can become more reliable. As a result, spoofing can be more securely prevented.

In the mobile phone 4, a security storage unit in a block which is under security management (security chip 12) is used as a storage location of vein information of a registration target while another block which is also under security management (security chip 12) is used as a place for executing biometric authentication. Accordingly, the mobile phone 4 can notify the service providing server 3ₓ of a more reliable message indicating successful biometric authentication. As a result, spoofing can be more securely prevented.

Also the mobile phone 4 encrypts registration address information described in a qualified certificate by using a public key for the qualified certificate. Therefore, the mobile phone 4 does not send out vein information to outside but maintains the vein information inside the security chip 12. On the other side, the mobile phone 4 sends out information (address) appended to the vein information, from the security chip 12, with the information maintained in a state that the information cannot be decrypted owing to a public key which can be decoded only by using a secret key even if the information is obtained by somebody. Accordingly, vein information can be managed in a highly secured state, and the service providing server 3ₓ can therefore be notified of a more reliable message indicating successful biometric authentication.

In the configuration as described above, a mutual authentication result (encryption key) is associated with biometric information which must have been input by a user who carried out mutual authentication by using a communication terminal device. By using the encryption key, a message indicating successful biometric authentication based on the biometric information associated with the biometric information is encrypted. A communication partner is notified of the encrypted message. Accordingly, the service providing system 1 or the mobile phone 4 can achieve stronger spoofing prevention.

### (6) Other Embodiments

The above embodiment has been described with reference to a case of dealing with veins as a living body. However, the present invention is not limited to this embodiment but information concerning various living bodies such as a fingerprint, a lip print, an iris, and a face can be used as an alternative.

In the above embodiment, a subscriber identity module card (SIM), a universal subscriber identity module (UIM), a memory stick (a registered trademark of Sony), or an optical disk can be used as the storage unit 14. In case of using a SIM or UIM, loaming of an integrated circuit (IC) chip is available so that usability of a user can be improved.

Further, in the above embodiment, timing of obtaining biometric information of an authentication target to be associated with an encryption key common to the service providing server is set to timing when mutual authentication with the service providing server 3ₓ succeeds. However, the biometric information may alternatively be obtained before the mutual authentication. In brief, biometric information of the authentication target needs only to be associated with an encryption key (common key) which is common to the service providing server 3ₓ.

Further, the above embodiment has been described with reference to a case that encrypted registration address information (i.e., information indicating a storage location of vein information of a registration target) is written in a qualified certificate. However, the present invention is not limited to this embodiment but a non-encrypted registration address may be written and/or encrypted vein information of the registration target may be written.

Also, the above embodiment has been described with reference to a case that biometric information is performed by the mobile phone 4. However, the present invention is not limited to this embodiment but may be modified so that the service providing server 3ₓ performs biometric authentication. In this modification, the security chip 12 is provided in the service providing server 3ₓ. If the image pickup unit 13, image pickup condition setup unit 31, vein information extraction unit 32, public key pair generation unit 33, registration unit 34, certificate obtaining unit 35, and authentication unit 43 as shown in FIGS. 3 to 5 are mounted on the security chip 12, the same effects as those of the embodiment described above can be obtained.

Still also, the above embodiment has been described with reference to a case of using the mobile phone 4. However, the present invention is not limited to this embodiment but is also applicable to various other communication terminal devices such as a personal digital assistant (PDA), a television receiver, and a personal computer, which are capable of making communication through a network. In a case of applying the present invention to a mobile communication device an individual user of which is assigned with a communication ID such as a telephone number or a mail address, one identical finger vein image is very often input for different services. Therefore, wasteful use of the volume of the security storage unit can be reduced particularly effectively.

The present invention can be used in the field of biometric authentication.

It should be understood by those skilled in the art that various modifications, combinations, sub-combinations and alterations may occur depending on design requirements and other factors insofar as they are within the scope of the appended claims or the equivalents thereof.

What is claimed is:

1. A communication system comprising a service providing server capable of making communications through a predetermined network, and a communication terminal device, wherein
the service providing server includes:
a mutual authentication unit that performs mutual authentication with the communication terminal device; and
a service providing unit that performs a service providing processing if a message indicating that the biometric authentication has succeeded is notified of from the communication terminal device, and
the communication terminal device includes:
a mutual authentication unit that performs mutual authentication with the service providing server;
an obtaining unit that obtains biometric information of an authentication target associated with an encryption key common to the service providing server, which is obtained as a successful result of the mutual authentication performed by the mutual authentication unit;
a biometric authentication unit that performs biometric authentication by using the biometric information of the authentication target which has been obtained by the obtaining unit, and biometric information of a registration target; and
a notification unit that encrypts the message by using the encryption key and notifies the service providing server of the message, if the biometric authentication of the biometric authentication unit succeeds.

2. A communication terminal device comprising:
a mutual authentication unit that performs mutual authentication with a service providing server;
an obtaining unit that obtains biometric information of an authentication target associated with an encryption key common to the service providing server, which is obtained as a successful result of the mutual authentication performed by the mutual authentication unit;
a biometric authentication unit that performs biometric authentication by using the biometric information of the authentication target, which has been obtained by the obtaining unit, and biometric information of a registration target; and
a notification unit that encrypts a message indicating that the biometric authentication has succeeded, by using the encryption key and notifies the service providing server of the message, if the biometric authentication of the biometric authentication unit succeeds.

3. The communication terminal device according to claim 2, further comprising an certificate receiving unit to which a certificate is issued from a predetermined certificate issuance device, the certificate including the biometric information of the registration target or storage location information of the biometric information, identification information identifying an own communication terminal, and a signature for verifying the biometric information or the storage location information and the identification information.

4. The communication terminal device according to claim 3, wherein
the biometric authentication unit performs biometric authentication in a block which is under security management, by using the biometric information of the registration target, which is stored in a storage unit in the block, or by using the vein information of the registration target, which is obtained from the storage unit.

5. The communication terminal device according to claim 3, wherein
among a public key and a secret key associated with the public key, the public key is used to encrypt the biometric information of the registration target or the storage location information of the biometric information, and a certificate including the encrypted biometric information of the registration target or the storage location information of the encrypted biometric information, the identification information, and the signature is issued from the issuance device.
